(19) United States
(12) Patent Application Publication
(10) Pub. No.: US 2015/0138719 A1
(43) Pub. Date: May 21, 2015

(54) Small High Performance Computer Enclosure

(71) Applicant: Dian Zhu, Chantilly, VA (US)

(72) Inventor: Dian Zhu, Chantilly, VA (US)

(21) Appl. No.: 14/082,129

(22) Filed: Nov. 16, 2013

(51) Int. Cl. G06F 1/20; G06F 1/18

(52) U.S. Cl. CPC G06F 1/20; G06F 1/187
USPC 361/679.33; 312/223.2

(57) ABSTRACT

A computer enclosure having a shape, size and specific orientation of components for incorporation of basic computer components, such as a mother board, power supply unit, data storage unit, and disc drive, as well as high-performance components, such as dual large fans, radiator, and long expansion card, with minimal internal air space separating the components, minimizing overall volume.

PATENT CITATIONS

| | | |
|---|---|---|
| U.S. Pat. No. 5,701,231 | May 1996 | Citicorp Development Center, |
| | | Inc. |
| U.S. Pat. No. 6,522,547 | April 2000 | Hewlett-Packard Company |
| U.S. Pat. No. 8,068,341 | March 2010 | Hong Fu Jin Precision Industry |
| | | (Shenzhen) Co., Ltd. |
| U.S. Pat. No. 8,085,536 | January 2010 | Hon Hai Precision Industry Co., |
| | | Ltd. |
| U.S. Pat. No. 8,243,437 | March 2010 | Hong Fu Jin Precision Industry |
| | | (Shenzhen) Co., Ltd. |

### BACKGROUND

1. Technical Field The disclosure relates to computer enclosures, and particularly to a computer enclosure configured for using the inner space efficiently translating to a relatively small volume.

2. Description of Related Art Computers, specifically those requiring a long expansion card (greater than 150 mm in length) often used for graphics intensive applications, typically require more enclosure space as compared to computers lacking long expansion cards. Similarly, computers, utilizing a radiator and/or a large fan(s) (120 mm in diameter or larger) for cooling, typically require a larger enclosure as compared to those lacking such cooling components. Therefore, a computer enclosure design which allows for incorporation of a long expansion card, radiator, and large fan(s) while most effectively minimizing overall volume is favorable as it occupies less space and is easier to transport and store.

### SUMMARY OF THE INVENTION

It is an object of the invention to provide a computer enclosure having a shape, size, and specific orientation of components for incorporation of basic computer components, such as a mother board, power supply unit, data storage unit, and disc drive, as well as high-performance components, such as dual large fans, radiator, and long expansion card, with minimal internal air space separating the components, minimizing overall volume.

Other objects and features of the present invention will become apparent from the following detailed description considered in conjunction with the accompanying drawings.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1A is a perspective external front view of the assembled computer enclosure

FIG. 1B is a perspective external rear view of the assembled computer enclosure.

FIG. 2A is a perspective front view of the assembled computer enclosure with panels removed.

FIG. 2B is a perspective rear view of the assembled computer enclosure with panels removed.

FIG. 3 is an exploded view of the computer enclosure and internal components.

FIG. 4 is a perspective view of the chassis of the computer enclosure with data storage unit and Disc drive.

FIG. 5A is a partially assembled, perspective view of the internal components of the computer enclosure with radiator.

FIG. 5B is a partially assembled, perspective view of the internal components of the computer enclosure.

FIG. 6A is a partially assembled, perspective view of the internal components of the computer enclosure with data storage cage.

FIG. 6B is a partially assembled, perspective view of the internal components of the computer enclosure with data storage cage and alternate dual fan orientation.

### LIST OF REFERENCE SYMBOLS

2 Computer enclosure
4 Front cover
6 Side panels
8 Top panel
10 Main chassis
10a Front plate
10b Rear plate
10c Base
10d Connecting components
12 Power supply bracket
14 Fan bracket
16 Data storage cage
20 Motherboard attachment
22 Expansion card
24 Power supply unit
26 Fan
28 Radiator
30 Data storage unit
32 Ventilation slits/holes
34 Disc opening
36 Disc drive

### DETAILED DESCRIPTION

It will be appreciated that the following description is intended to refer to specific examples of structure selected for illustration in the drawings and is not intended to define or limit the disclosure, other than in the appended claims.

We provide a computer enclosure designed to accommodate a motherboard, expansion card, and dual cooling fans with space for a data storage unit, disc drive, power supply, and other computer accessories and components. The enclosure provides for orientation of the computer hardware and components in a manner that minimizes overall volume of the computer.

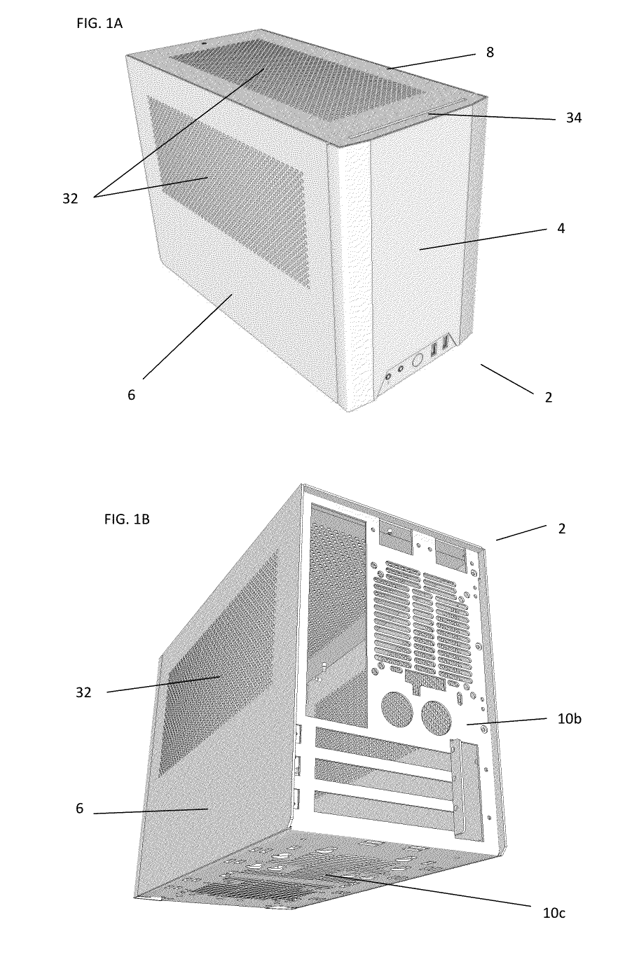

According to the preferred embodiment of the invention referring to FIGS. 1-6, the computer enclosure 2 has a rectangular-block-shaped design, which when assembled most efficiently with respect to volume (meaning the enclosure houses basic components, such as a mother board, power supply unit, data storage unit, and disc drive, and high-performance components, such as dual fans, radiator, and long expansion card, with minimal internal air space separating the components) is 160 mm wide by 240 mm tall by 328 mm deep. The enclosure has a front cover 4 attached to a main chassis 10, which consists of a front plate 10a, rear plate 10b, base 10c, and connecting components 10d, side panels 6, and a top panel 8. The side panels 6, top panel 8, rear plate 10b, and base 10c, may have a multitude of ventilation slits/ holes 32, which allow for dissipation of air for cooling of the internally housed components. All components of the computer enclosure may be constructed of a rigid metallic material, such as aluminum or steel, a rigid polymer based material, such as acrylic or plastic, or any other suitable material.

The front cover 4 attaches to the front plate 10a of the chassis 10 by an interlocking design mechanism, an external fastener, such as screw, bolt, or clip, or any other suitable connecting mechanism or device. The side panels 6 attach to the chassis 10 by an interlocking design mechanism, an external fastener, such as screw, bolt, or clip, or any other suitable connecting mechanism or device.

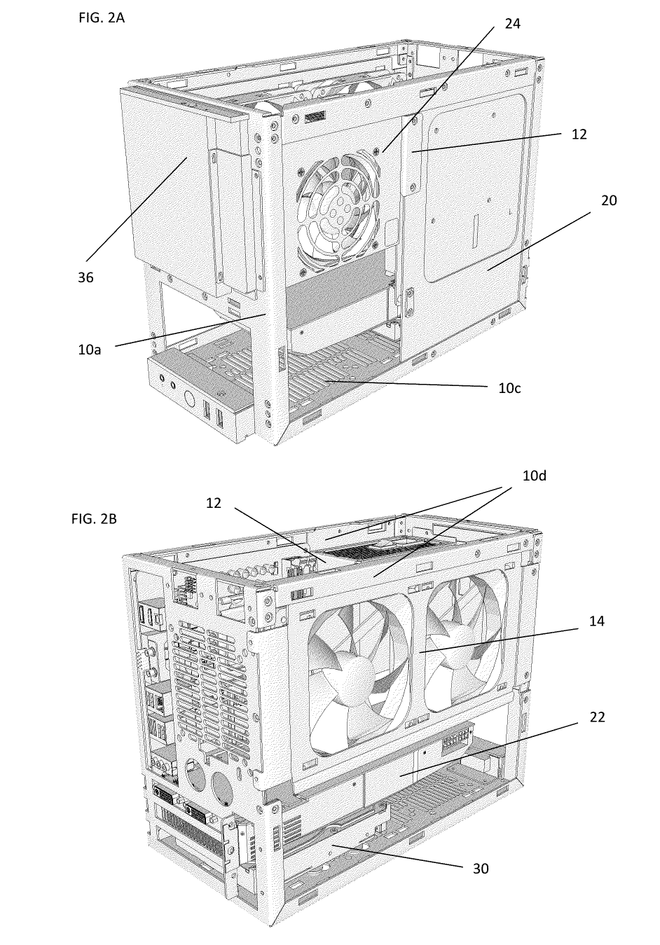

According to an embodiment of the invention referring to FIGS. 2A, 3, 4, and 5, the fan bracket 14 attaches to the side of the chassis 10 opposite the motherboard attachment 20 and power supply unit 24 by an interlocking design mechanism, an external fastener, such as screw, bolt, or clip, or any other suitable connecting mechanism or device. The fan bracket 14 is adjacent to and housed within one of the side panels 6. The fan bracket 14 is of appropriate size and dimensions to house a dual fan 26 arrangement of the customary size in accordance with industry standards. The orientations of the fan bracket 14 and dual fans 26 within the upper region of the internal space of the computer enclosure 2 allows for a long expansion card to be located below the fans 26 for optimization or spatial efficiency.

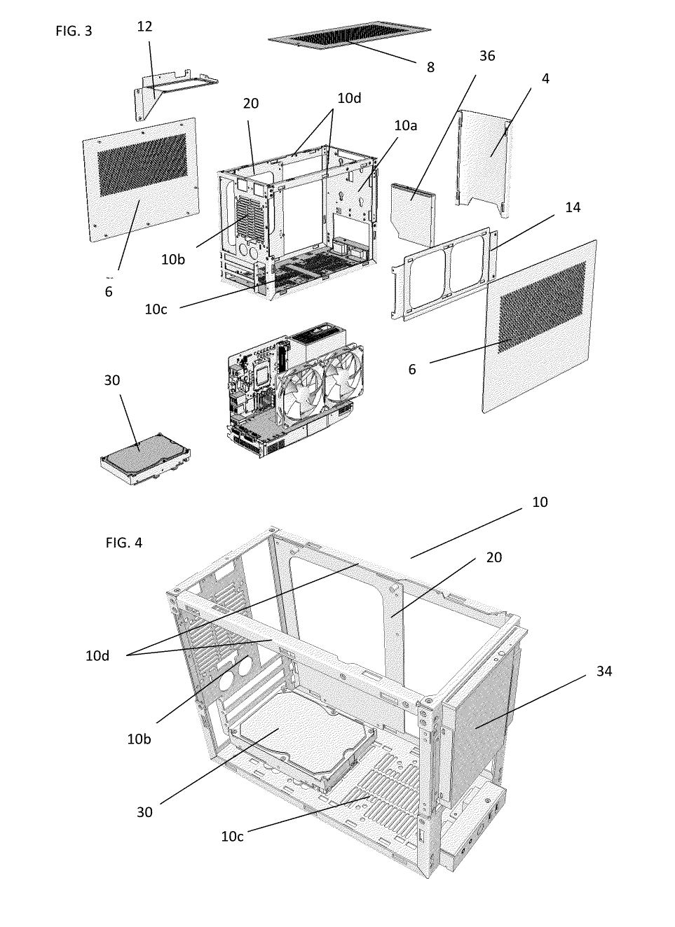

According to an embodiment of the invention referring to FIGS. 2A and 3, the power supply bracket 12 attaches to the side of the chassis 10 opposite the fan bracket 14 by an interlocking design mechanism, an external fastener, such as screw, bolt, or clip, or any other suitable connecting mechanism or device. The power supply bracket 12 is adjacent to and housed within one of the side panels 6. The power supply bracket 12 is of appropriate dimensions to house a power supply unit 24 of the customary size in accordance with industry standards. This places the power supply unit 24 and motherboard directly across the dual fan 26 arrangement so that one fan produces airflow towards the power supply unit 24 and the other fan produces air flow towards the motherboard. The orientation of the power supply unit 24 also provides the benefit of ventilation in the upwards direction leading to more efficient cooling as the hot air rises and allows for a long expansion card to be located below power supply unit 24 and fans 26 for optimization of spatial efficiency.

According to an embodiment of the invention referring to FIGS. 2A, 3, and 4, the motherboard attachment 20 is a connecting component of the chassis 10 and is of appropriate dimensions to attach a motherboard of customary size in accordance with industry standards.

According to an embodiment of the invention referring to FIGS. 1A and 4, the front plate 10a is able to attach a disc drive 36 oriented vertically so that the disc can be inserted and removed through the disc slit 34 within the top panel 8.

According to an embodiment of the invention referring to FIGS. 1A and 1B, the front cover 4 has USB openings, microphone/ auxiliary openings, and a power button. The rear plate has various 10b openings for ventilation and electrical components.

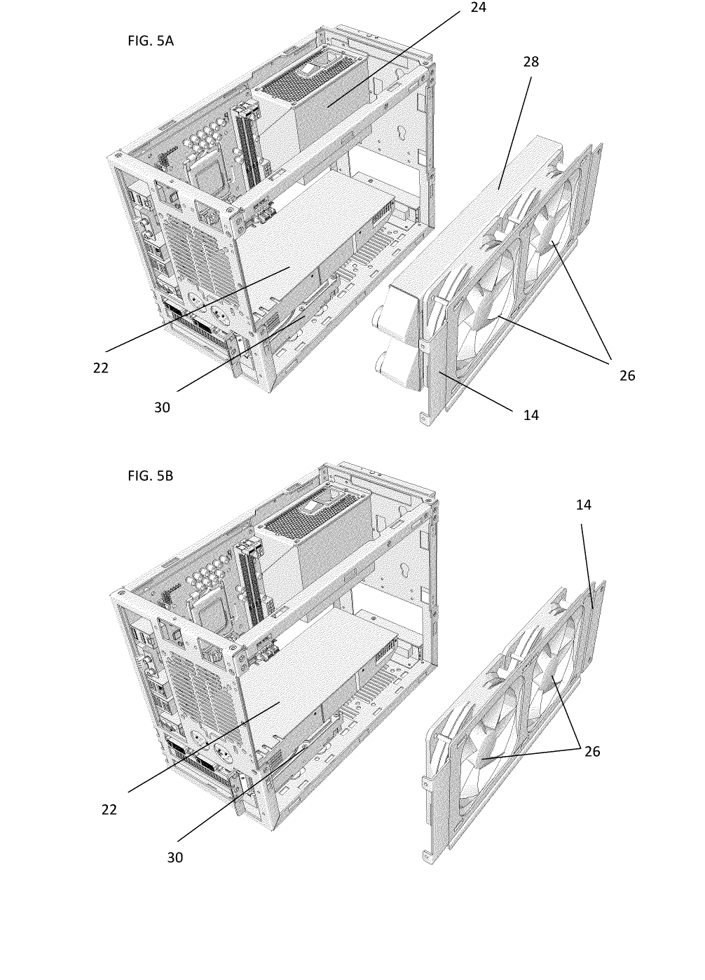

According to an embodiment of the invention referring to FIGS. 5A and 5B, a data storage unit 30 can be mounted under the expansion card 22 or attached to the front plate 10a in place of a disc drive 36.

According to an embodiment of the invention referring to FIG. 5A, a rectangular radiator 28 cooling apparatus can be attached to dual fans 26 occupying the space above the expansion card 22 and between the fans and motherboard.

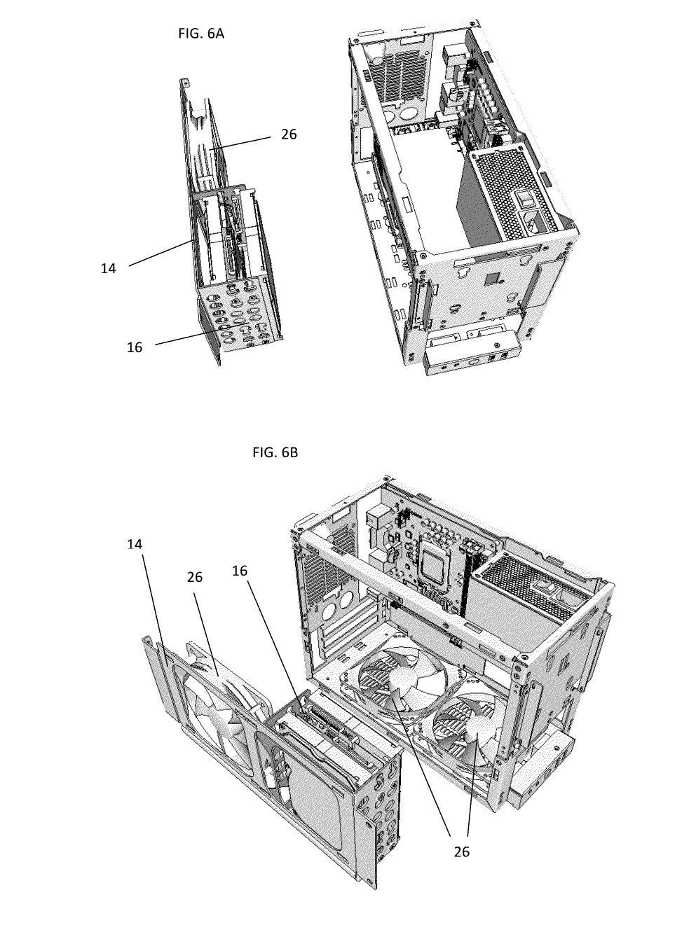

According to an embodiment of the invention referring to FIGS. 6A and 6B, a data storage cage 16 is mounted to the fan bracket 14. The data storage cage 16 is of appropriate size and dimensions to house a data storage unit 30 of the customary size in accordance with industry standards. For additional ventilation and cooling dual fans 26 can be mounted on the base 10c below the expansion card 22.

Although the enclosure has been described in connection with specific forms thereof, it will be appreciated that a wide variety of equivalents may be substituted for the specified elements described herein without departing from the spirit and scope of this disclosure as described in the appended claims.

1. A computer enclosure comprising:
outer panels forming an internal space with a width of no more than two hundred millimeters and height of no more than three hundred millimeters sized and shaped to accommodate at least a mother board, expansion card, and one or more fans;
an attachment for one or more fans on one side panel of the enclosure; and
an attachment for a mother board on the opposite side panel.

2. The computer enclosure according to claim 1, wherein dual fans are mounted on the side panel, one of which is directly across from and produces an air flow towards or away from the motherboard.

3. The computer enclosure according to claim 1, wherein a fan and data storage unit are mounted on the side panel and the fan is directly across from and produces an air flow towards or away from the motherboard.

4. The computer enclosure according to claim 3, wherein dual fans are mounted on the base producing an upward or downward air flow.

5. The computer enclosure according to claim 2, wherein a radiator is attached to the dual fan arrangement.

6. A computer enclosure comprising:
outer panels forming an internal space with a width of no more than two hundred millimeters and height of no more than three hundred millimeters sized and shaped to accommodate at least a mother board, expansion card, power supply unit, and one or more fans;
an attachment for one or more fans on one side panel of the enclosure;
an attachment for a mother board on the opposite side panel; and
an attachment for a power supply unit on the same side panel as the motherboard.

7. The computer enclosure according to claim 6, wherein dual fans are mounted on the side panel, one of which is directly across and produces an air flow towards or away from the motherboard and the other produces an air flow towards or away from the power supply unit.

8. The computer enclosure according to claim 6, wherein a fan and data storage unit are mounted on the side panel and the fan is directly across from and produces an air flow towards or away from the motherboard.

9. The computer enclosure according to claim 8, wherein dual fans are mounted on the base producing an upward or downward air flow.

10. The computer enclosure according to claim 7, wherein a radiator is attached to the dual fan arrangement.

11. A computer enclosure comprising:
outer panels forming an internal space with a width of no more than two hundred millimeters, height of no more than three hundred millimeters, and depth of no more than four hundred millimeters shaped to accommodate at least a mother board, expansion card, power supply unit, and one or more fans;
an attachment for one or more fans on one side panel of the enclosure;
an attachment for a mother board on the opposite side panel; and
an attachment for a power supply unit on the same side panel as the motherboard.

12. The computer enclosure according to claim 11, wherein dual fans are mounted on the side panel, one of which is directly across and produces an air flow towards or away from the motherboard and the other produces an air flow towards or away from the power supply.

13. The computer enclosure according to claim 11, wherein a fan and data storage unit are mounted on the side panel and the fan is directly across from and produces an air flow towards or away from the motherboard.

14. The computer enclosure according to claim 13, wherein dual fans are mounted on the base producing an upward or downward air flow.

15. The computer enclosure according to claim 12, wherein a radiator is attached to the dual fan arrangement.
